(19) United States
(12) Patent Application Publication
(10) Pub. No.: US 2024/0069423 A1
(43) Pub. Date: Feb. 29, 2024

(54) PROJECTOR

(71) Applicant: SEIKO EPSON CORPORATION, Tokyo (JP)

(72) Inventor: Yutaka AMANO, Matsumoto-shi, Nagano-ken (JP)

(21) Appl. No.: 18/454,926

(22) Filed: Aug. 24, 2023

(30) Foreign Application Priority Data
Aug. 24, 2022 (JP) 2022-133280

(51) Int. Cl. G03B 21/20; G03B 21/00

(52) U.S. Cl. CPC G03B 21/2073; G03B 21/006; G03B 21/2066

(57) ABSTRACT

A projector of the present disclosure includes a light source configured to emit first light, which is non-linearly polarized light, a polarization conversion unit configured to convert the first light into predetermined linearly polarized light, a light modulation device including a liquid crystal panel which modulates the predetermined linearly polarized light, and a superimposing optical system configured to superimpose, on the liquid crystal panel, the predetermined linearly polarized light made incident from the polarization conversion unit. The polarization conversion unit includes a polarizing separator configured to separate the first light into second light and third light and a phase difference plate. The polarizing separator includes a polarizing separation plate and a reflection plate disposed to be separated from and opposed to each other, the polarizing separation plate is provided in a tilted state with respect to a principal ray of the first light and separates the first light by transmitting a first linearly polarized light component in the first light toward the superimposing optical system as the second light and reflecting, as the third light, a second linearly polarized light component in the first light, and the reflection plate reflects the third light toward the superimposing optical system.

The present application is based on, and claims priority from JP Application Serial Number 2022-133280, filed Aug. 24, 2022, the disclosure of which is hereby incorporated by reference herein in its entirety.

### BACKGROUND

### 1. Technical Field

The present disclosure relates to a projector.

### 2. Related Art

There has been known a projector including one liquid crystal panel as a light modulation element, a so-called single-plate projector (see, for example, Chinese Utility Model Registration No. 201622432 (Patent Literature 1) and Chinese Utility Model Registration No. 212515320 (Patent Literature 2)). In Patent Literature 1, predetermined linearly polarized light in light made incident from a light source is made incident on the liquid crystal panel by providing a reflective polarization element as an incident-side polarization plate of the liquid crystal panel. In Patent Literature 2, an LED that emits nonpolarized light is used as a light source.

When the nonpolarized light is transmitted through the incident-side polarization plate, light in a polarization direction different from a transmission axis of the incident-side polarization plate is cut. Therefore, when the light source that emits nonpolarized light is used in the single-plate projector, light use efficiency of the light source is deteriorated.

In recent years, a further reduction in the weight of a projector has been desired. Therefore, there has been a demand for provision of a new technique that can efficiently use light emitted from a light source while achieving a reduction in the weight of an apparatus configuration.

### SUMMARY

In order to solve the problem described above, according to an aspect of the present disclosure, there is provided a projector including: a light source configured to emit first light, which is non-linearly polarized light; a polarization conversion unit configured to convert the first light made incident from the light source into predetermined linearly polarized light; a light modulation device including a liquid crystal panel which modulates the predetermined linearly polarized light converted by the polarization conversion unit; and a superimposing optical system configured to superimpose, on the liquid crystal panel, the predetermined linearly polarized light made incident from the polarization conversion unit. The polarization conversion unit includes: a polarizing separator configured to separate the first light into second light and third light based on polarized light components; and a phase difference plate configured to align polarization directions of the second light and the third light, the polarizing separator includes a polarizing separation plate and a reflection plate disposed to be separated from and opposed to each other, the polarizing separation plate is provided in a tilted state with respect to a principal ray of the first light and separates the first light by transmitting a first linearly polarized light component in the first light toward the superimposing optical system as the second light and reflecting, as the third light, a second linearly polarized light component in a polarization direction different from a polarization direction of the first linearly polarized light component in the first light, and the reflection plate reflects the third light made incident from the polarizing separation plate toward the superimposing optical system.

### BRIEF DESCRIPTION OF THE DRAWINGS

FIG. 1 is a schematic configuration diagram of a projector in a first embodiment.

FIG. 2 is a plan view showing a main part configuration of a polarization conversion unit in the first embodiment.

FIG. 3 is a plan view showing a main part configuration of a polarization conversion unit in a second embodiment.

FIG. 4 is a plan view showing a main part configuration of a polarization conversion unit in a third embodiment.

FIG. 5 is a plan view showing a main part configuration of a polarization conversion unit in a fourth embodiment.

FIG. 6 is a plan view showing a main part configuration of a polarization conversion unit in a fifth embodiment.

FIG. 7 is a plan view showing a main part configuration of a polarization conversion unit in a sixth embodiment.

FIG. 8 is a plan view showing a main part configuration of a projector in a seventh embodiment.

FIG. 9 is a plan view showing a main part configuration of a polarization conversion unit in a modification.

### DESCRIPTION OF EMBODIMENTS

Embodiments of the present disclosure are explained in detail below with reference to the drawings. In the drawings referred to in the following explanation, characteristic portions are sometimes enlarged and shown for convenience in order to clearly show characteristics, and dimension ratios and the like of components are not always the same as actual dimension ratios and the like.

### First Embodiment

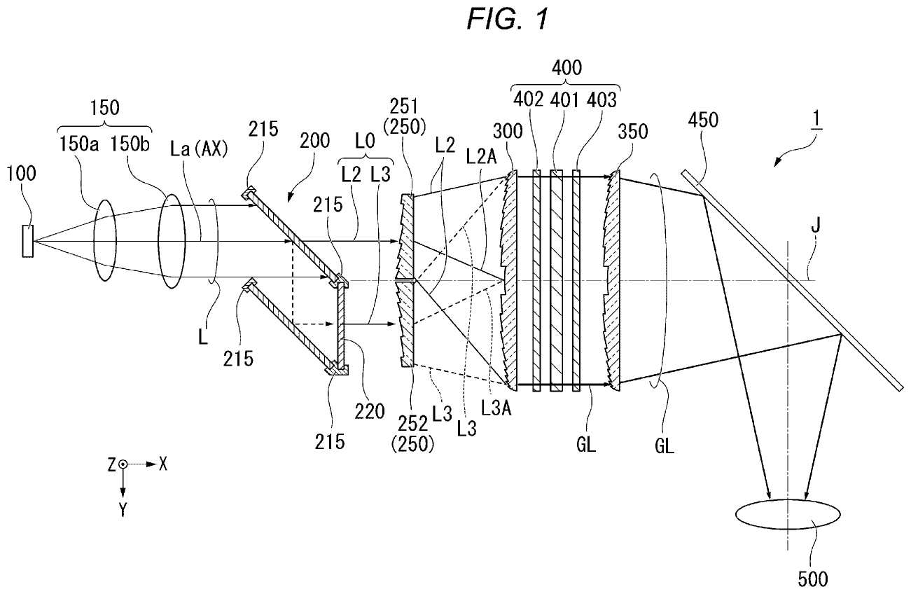

FIG. 1 is a schematic configuration diagram of a projector in a first embodiment.

In the drawings referred to below, scales of dimensions are sometimes differentiated and shown depending on components in order to clearly show the components.

As shown in FIG. 1, a projector 1 includes a light source 100, an optical system 150, a polarization conversion unit 200, a superimposing optical system 250, a collimating optical system 300, a condensing optical system 350, a light modulation device 400, a mirror 450, and a projection optical system 500.

In the projector 1 in this embodiment, an axis on which a principal ray La of illumination light (first light) L emitted from the light source 100 passes is defined as an illumination optical axis AX and an axis passing the center of the light modulation device 400 and serving as a reference for disposing the components of the projector 1 is defined as a reference axis J.

In the following explanation, an XYZ orthogonal coordinate system is used for the explanation according to necessity. A Z axis is an axis extending in the up-down direction of the projector 1. An X axis is an axis parallel to the illumination optical axis AX and the reference axis J. A Y axis is an axis extending along an image projection direction of the projector 1 and is orthogonal to the X axis and the Z axis.

In the following explanation, when dispositions and shapes of members in the projector 1 are explained, a direction parallel to a Z-axis direction equivalent to the height in a front view of the projector 1 viewed from an image projection side is referred to as up-down direction Z, a direction parallel to an X-axis direction equivalent to a lateral width in the front view of the projector 1 viewed from the image projection side is referred to as left-right direction X, and a direction parallel to a Y-axis direction equivalent to depth in the front view of the projector 1 viewed from the image projection side is referred to as front-rear direction Y. In some case, a +Z side, which is one side of the Z direction, is referred to as “upper side (+Z)”, a −Z side, which is the other side of the Z direction, is referred to as “lower side (−Z)”, a +X side, which is one side of the X direction, is referred to as “right side (+X)”, a −X side, which is the other side of the X direction, is referred to as “left side (−X)”, a +Y side, which is one side of the Y direction in which image light is projected, is referred to as “front side (+Y)”, and a−Y side, which is the other side of the Y direction, is referred to as “rear side (−Y)”. The upper side (+Z), the lower side (−Z), the front side (+Y), the rear side (−Y), the right side (+X), and the left side (−X) are only definitions for explaining a disposition relation among the components of the projector 1 and do not limit actual disposition postures and directions in the projector 1.

The light source 100 and the optical system 150 are disposed along the illumination optical axis AX.

The light source 100 emits nonlinearly polarized white light as illumination light L. In this specification, nonlinearly polarized light means, for example, nonpolarized light (random polarized light), circularly polarized light, or elliptically polarized light.

In the case of this embodiment, the light source 100 is configured by, for example, a light emitting diode (LED) and emits, as the illumination light (the first light) L, nonpolarized light, that is, light in a state in which a plurality of linearly polarized lights overlap and a polarization state is not observed as a whole. It is possible to reduce the projector 1 in size and weight by using the LED as the light source 100 in this way.

The optical system 150 takes in and collimates the illumination light L emitted from the light source 100. The optical system 150 is configured by, for example, two convex lenses 150a and 150b. The number of lenses configuring the optical system 150 is not particularly limited and may be one or may be three or more.

The illumination light L collimated by the optical system 150 is made incident on the polarization conversion unit 200. The polarization conversion unit 200 converts the illumination light L made incident from the light source 100 into converted light L0, which is predetermined linearly polarized light. A configuration of the polarization conversion unit 200 is explained below.

The superimposing optical system 250 superimposes, on the light modulation device 400, the converted light L0 made incident from the polarization conversion unit 200. Since the superimposing optical system 250 in this embodiment has negative power, the superimposing optical system 250 can enlarge and project, on the light modulation device 400 larger than the superimposing optical system 250, light made incident from the polarization conversion unit 200.

The light modulation device 400 is a single-plate liquid crystal light modulation device including a liquid crystal panel adapted to color display. Specifically, the light modulation device 400 includes a liquid crystal panel 401 including a color filter, an incident-side polarization plate 402, and an emission-side polarization plate 403. It is possible to achieve a reduction in the size of the projector 1 by adopting the single-plate liquid crystal light modulation device in this way.

The liquid crystal panel 401 modulates, according to image information, the converted light L0 made incident from the polarization conversion unit 200 and generates image light GL. The incident-side polarization plate 402 is provided on a light incident side of the liquid crystal panel 401. The emission-side polarization plate 403 is provided on a light emission side of the liquid crystal panel 401. The incident-side polarization plate 402 and the emission-side polarization plate 403 are disposed such that polarization axes thereof are orthogonal to each other.

The collimating optical system 300 is disposed between the superimposing optical system 250 and the light modulation device 400. Specifically, the collimating optical system 300 is disposed on the light incident side of the incident-side polarization plate 402. The collimating optical system 300 collimates light made incident from the superimposing optical system 250 and makes the light incident on the light modulation device 400. In this embodiment, the collimating optical system 300 is configured by a Fresnel lens and functions as a convex lens having positive power. Therefore, the thickness in the optical axis direction of the collimating optical system 300 is reduced to reduce a dimension in the left-right direction X extending along the reference axis J of the projector 1.

The condensing optical system 350 is disposed on the light emission side of the liquid crystal panel 401. Specifically, the condensing optical system 350 is disposed on the light emission side of the emission-side polarization plate 403. The condensing optical system 350 condenses light emitted from the liquid crystal panel 401. In this embodiment, the condensing optical system 350 is configured by a Fresnel lens and functions as a convex lens having positive power. Therefore, the thickness in the optical axis direction of the condensing optical system 350 is reduced to reduce a dimension in the left-right direction X extending along the reference axis J of the projector 1.

It is possible to reduce a lens diameter of the projection optical system 500 disposed at a post stage by condensing the light emitted from the liquid crystal panel 401 with the condensing optical system 350.

The positions of the condensing optical system 350 and the emission-side polarization plate 403 may be interchanged.

The mirror 450 is disposed to form an angle of 45° with respect to the reference axis J. The mirror 450 bends, by 90°, an optical path of the image light GL emitted from the light modulation device 400 and makes the image light GL incident on the projection optical system 500. When a layout for disposing the projection optical system 500 along the reference axis J is adopted, the mirror 450 can be omitted.

The projection optical system 500 is configured by a projection lens. The projection optical system 500 projects, toward a not-shown screen, the image light GL modulated by the light modulation device 400 and made incident through the mirror 450. The number of projection lenses configuring the projection optical system 500 is not particularly limited and may be one or may be plural. A lens on the light incident side most among a plurality of lenses configuring the projection optical system 500 may be used as the condensing optical system 350.

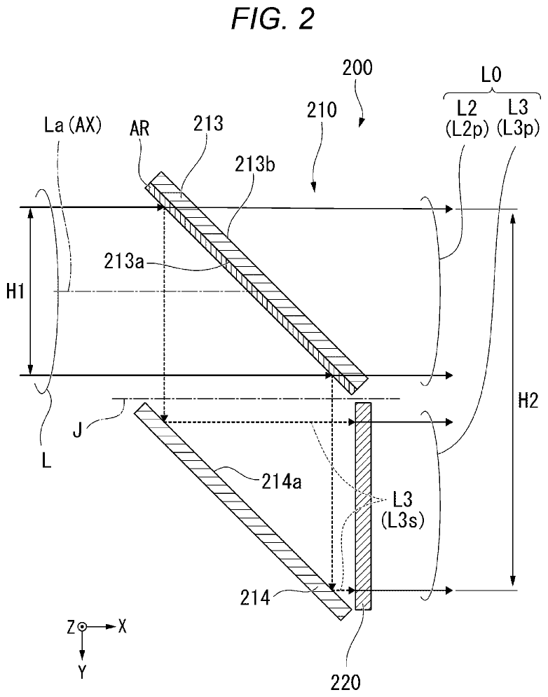

FIG. 2 is a plan view showing a main part configuration of the polarization conversion unit 200. FIG. 2 is a plan view of the polarization conversion unit 200 viewed from the upper side (+Z).

As shown in FIG. 2, the polarization conversion unit 200 includes the polarizing separator 210 and a phase difference plate 220.

The polarizing separator 210 separates the illumination light L into second light L2 and third light L3 based on polarized light components. The polarizing separator 210 includes a polarizing separation plate 213 and a reflection plate 214 disposed to be separated from and opposed to each other.

The polarizing separation plate 213 includes a light incident surface 213a and a light emission surface 213b. The light incident surface 213a is a surface on which the illumination light L emitted from the light source 100 is made incident. The light emission surface 213b is a surface parallel to and facing oppositely to the light incident surface 213a and is a surface that emits light transmitted through the polarizing separation plate 213.

The polarizing separation plate 213 is provided in a state in which the light incident surface 213a is tilted with respect to the principal ray La of the illumination light L. The polarizing separation plate 213 is disposed such that the light incident surface 213a forms an angle of 35° to 55°, specifically, 45° with respect to the illumination optical axis AX (the principal ray La of the illumination light L). Therefore, like the light incident surface 213a, the light emission surface 213b is disposed to form an angle of 45° with respect to the illumination optical axis AX.

In the case of this embodiment, a reflection prevention film AR is provided on the light incident surface 213a. Consequently, since reflection of the illumination light L by the interface between the light incident surface 213a and an air layer is suppressed, the illumination light L can be efficiently made incident on the light incident surface 213a.

The polarizing separation plate 213 has a polarizing separation function for the illumination light L, which is nonpolarized light. That is, the polarizing separation plate 213 mainly reflects an S-polarized light component on the surface of the light incident surface 213a and mainly transmits a P-polarized light component on the surface of the light incident surface 213a among polarized light components included in the nonpolarized illumination light L. The polarizing separation plate 213 in this embodiment is configured by, for example, forming a dielectric multilayer film on a transmissive substrate such as glass.

The polarizing separation plate 213 transmits a P-polarized light component (a first linearly polarized light component) L2p in the illumination light L as the second light L2 and reflects an S-polarized light component (a second linearly polarized light component) L3s in a polarization direction different from a polarization direction of the P-polarized light component in the nonpolarized illumination light L to the front side (+Y) as the third light L3.

In this way, the polarizing separation plate 213 separates the illumination light L into the second light L2 and the third light L3.

The reflection plate 214 is disposed with a gap on the front side (+Y) of the polarizing separation plate 213. The reflection plate 214 includes a light reflection surface 214a parallel to the light incident surface 213a of the polarizing separation plate 213. The reflection plate 214 is disposed such that the light reflection surface 214a forms an angle of 45° with respect to the illumination optical axis AX (the principal ray La of the illumination light L).

The reflection plate 214 in this embodiment is configured by, for example, a metal mirror obtained by forming a metal film on a substrate surface. The reflection plate 214 reflects the third light L3 made incident from the polarizing separation plate 213 toward the superimposing optical system 250. The reflection plate 214 may be configured by a mirror obtained by forming, on the substrate surface, a dielectric multilayer film that reflects an S-polarized light component.

The phase difference plate 220 is a plate-like member that aligns polarization directions of the second light L2 and the third light L3.

The phase difference plate 220 in this embodiment is configured by a half wave plate and provided in an optical path of the third light L3 reflected by the reflection plate 214. Examples of the phase difference plate 220 in this embodiment are not limited to but include the following. The phase difference plate 220 is formed by, for example, extending plate-like resin or extending film of resin and fixing the extended film of the resin to a substrate. Alternatively, the phase difference plate 220 is a plate-like member configured by forming, with a nanoimprint method, a periodic structure smaller than the wavelength of light on the surface of a plastic substrate. The phase difference plate 220 may be formed using an inorganic material such as crystal, sapphire, lithium niobate, or calcite.

The third light L3 reflected by the reflection plate 214 is transmitted through the phase difference plate 220. The third light L3 is transmitted through the phase difference plate 220 to be converted into a P-polarized light component L3p from the S-polarized light component L3s. That is, the phase difference plate 220 aligns the polarization direction (the P-polarized light component L3p) of the third light L3 with the polarization direction (the P-polarized light component L2p) of the second light L2.

In this embodiment, the polarizing separation plate 213, the reflection plate 214, and the phase difference plate 220 are respectively held by plate holders 215 as shown in FIG. 1. The plate holders 215 are fixed to an inner surface of a housing (not shown) forming at least a part of the exterior of the projector 1. In this way, the polarizing separation plate 213, the reflection plate 214, and the phase difference plate 220 are highly accurately disposed in predetermined positions by the plate holders 215. The plate holders 215 that hold the polarizing separation plate 213, the reflection plate 214, and the phase difference plate 220 may be respectively separately configured or may be integrally configured.

In this way, the polarization conversion unit 200 in this embodiment can convert the nonpolarized illumination light L into the converted light L0 including the second light L2 and the third light L3 aligned with the P-polarized light. In this specification, the polarization directions of the second light L2 and the third light L3 being aligned includes not only a case in which the polarization directions of the second light L2 and the third light L3 completely coincide, that is, a state in which an angle formed by the polarization direction of each of the second light L2 and the third light L3 is 0° but also a state in which the angle formed by the polarization direction of each of the second light L2 and the third light L3 is within ±20°.

In the polarization conversion unit 200, the width in the front-rear direction Y of the light incident surface 213a of the polarizing separation plate 213 is represented as first width H1 and the total width in the front-rear direction Y of the polarizing separation plate 213 and the reflection plate 214 is represented as second width H2. The first width H1 is equivalent to the light beam width of the illumination light L made incident on the polarization conversion unit 200 and the second width H2 is equivalent to the light beam width of the converted light L0 emitted from the polarization conversion unit 200. In the case of this embodiment, the second width H2 is equivalent to double of the first width H1.

With the polarization conversion unit 200 in this embodiment, it is possible to generate the converted light L0 having the light beam width twice as large as the light beam width of the illumination light L, the polarization direction of the converted light L0 being aligned with the predetermined linearly polarized light.

The polarization direction of the converted light L0 corresponds to a polarization direction in which the converted light L0 is transmitted through a transmission axis of the incident-side polarization plate 402 of the light modulation device 400. The predetermined linearly polarized light is equivalent to polarized light transmitted through the transmission axis of the incident-side polarization plate 402 of the light modulation device 400. That is, the polarization conversion unit 200 can convert the illumination light L into the converted light L0 of the predetermined linearly polarized light (P-polarized light) that can be transmitted through the incident-side polarization plate 402. The converted light L0 emitted from the polarization conversion unit 200 is made incident on the superimposing optical system 250.

Subsequently, a configuration of the superimposing optical system 250 is explained.

As shown in FIG. 1, the superimposing optical system 250 includes a first lens section (a first optical member) 251 on which the second light L2 in the converted light L0 emitted from the polarization conversion unit 200 is made incident and a second lens section (a second optical member) 252 on which the third light L3 in the converted light L0 emitted from the polarization conversion unit 200 is made incident.

The superimposing optical system 250 is configured by a Fresnel lens. That is, the first lens section 251 and the second lens section 252 are respectively configured by Fresnel lenses. Consequently, the thickness in the optical axis direction of the superimposing optical system 250 is reduced to reduce the dimension in the left-right direction X extending along the reference axis J of the projector 1.

The Fresnel lens configuring the first lens section 251 is decentered. The second light L2 emitted from the first lens section 251 is made to form an image in a position deviating to the rear side (+Y) in the front-rear direction Y orthogonal to the optical axis of the first lens section 251.

Similarly, the Fresnel lens configuring the second lens section 252 is decentered. The third light L3 emitted from the second lens section 252 is made to form an image in a position deviating to the front side (−Y) in the front-rear direction Y orthogonal to the optical axis of the second lens section 252.

The first lens section 251 and the second lens section 252 may be integrally formed or may be separately formed.

In the superimposing optical system 250 in this embodiment, a principal ray L2A of the second light L2 emitted from the first lens section 251 and a principal ray L3A of the third light L3 emitted from the second lens section 252 come closer to each other toward the light modulation device 400. Therefore, with the superimposing optical system 250, it is possible to superimpose the second light L2 and the third light L3 in a pixel formation region of the liquid crystal panel 401, which is a light irradiation region of the light modulation device 400, by adjusting the positions in the front-rear direction Y of the second light L2 and the third light L3. Accordingly, by superimposing the second light L2 and the third light L3, the superimposing optical system 250 can uniformize an in-plane brightness distribution of the converted light L0 illuminating the liquid crystal panel 401. Therefore, it is possible to generate an excellent image without brightness unevenness in a plane by the light modulation device 400.

Light emission surfaces of the first lens section 251 and the second lens section 252 may be disposed in a state in which the light emission surfaces are tilted to be directed to the reference axis J side of the projector 1 (a tilt state). In this case, the principal ray L2A of the second light L2 emitted from the first lens section 251 and the principal ray L3A of the third light L3 emitted from the second lens section 252 can be more easily brought close to each other. By tilting the first lens section 251 and the second lens section 252 in this way, it is possible to reduce an amount of eccentricity of the Fresnel lenses configuring the first lens section 251 and the second lens section 252.

By performing only tilt adjustment for the first lens section 251 and the second lens section 252, a superimposition amount on the liquid crystal panel 401 of the second light L2 and the third light L3 may be controlled to prevent the first lens section 251 and the second lens section 252 from being decentered.

The converted light L0 emitted from the superimposing optical system 250 is collimated by the collimating optical system 300 and made incident on the light modulation device 400. The polarization direction of the converted light L0 is aligned with the polarization direction of the polarized light transmitted through the transmission axis of the incident-side polarization plate 402 of the light modulation device 400 by the polarization conversion unit 200. Therefore, the converted light L0 is transmitted through the incident-side polarization plate 402 and efficiently made incident on the liquid crystal panel 401. Light modulated by the liquid crystal panel 401 is transmitted through the emission-side polarization plate 403 and emitted as the image light GL. The image light GL emitted from the light modulation device 400 in this way is condensed by the condensing optical system 350 and reflected by the mirror 450 to be made incident on the projection optical system 500 and emitted toward the not-shown screen.

As explained below, the projector 1 in this embodiment includes the light source 100 that emits the illumination light L, which is the nonlinearly polarized light (the nonpolarized light), the polarization conversion unit 200 that converts the illumination light L made incident from the light source 100 into the converted light L0, which is the predetermined linearly polarized light, the light modulation device 400 including the liquid crystal panel 401 which modulates the converted light L0 converted by the polarization conversion unit 200, and the superimposing optical system 250 that superimposes, on the liquid crystal panel 401, the converted light L0 made incident from the polarization conversion unit 200. The polarization conversion unit 200 includes the polarizing separator 210 that separates the illumination light L into the second light L2 and the third light L3 based on polarized light components and the phase difference plate 220 that aligns the polarization directions of the second light L2 and the third light L3 with the predetermined linearly polarized light. The polarizing separator 210 includes the polarizing separation plate 213 and the reflection plate 214. The polarizing separation plate 213 is provided in the tilted state with respect to the principal ray La of the illumination light L and separates the illumination light L by transmitting the P-polarized light component in the illumination light L as the second light L2 and reflecting the S-polarized light component in the illumination light L as the third light L3. The reflection plate 214 reflects the third light L3 made incident from the polarizing separation plate 213 toward the superimposing optical system 250.

With the projector 1 in this embodiment, the polarization direction of the illumination light L, which is the nonpolarized light, emitted from the light source 100 can be converted into, by the polarization conversion unit 200, the converted light L0 aligned with the P-polarized light. Therefore, it is possible to more efficiently make the illumination light L emitted from the light source 100 incident on the liquid crystal panel 401 of the light modulation device 400 by converting the illumination light L into the P-polarized light compared with when the illumination light L, which is the nonpolarized light, is aligned with the P-polarized light using a polarization plate. Accordingly, it is possible to improve light use efficiency of the illumination light L emitted from the light source 100.

The polarization conversion unit 200 is configured by the polarizing separation plate 213 and the reflection plate 214 disposed to be separated from each other. Therefore, it is possible to achieve a reduction in weight compared with when a polarizing separation element and a reflection mirror are provided in an optical member such as a prism.

The polarization conversion unit 200 can expand, to the second width H2, the light beam width of the converted light L0 obtained by aligning, with the P-polarized light, the polarization direction of the illumination light L having the first width H1 made incident on the light incident surface 213a of the polarizing separation plate 213. Therefore, the polarization conversion unit 200 can expand the light beam width of the illumination light L, which is the incident light, to double. Since the light beam width of the converted light L0 is expanded in this way, it is possible to reduce a degree of the superimposing optical system 250 expanding the light beam width of the converted light L0 (lens power). That is, since expansion magnification of the superimposing optical system 250 is reduced, it is possible to reduce the distance in the reference axis J direction from the superimposing optical system 250 to the light modulation device 400. It is possible to realize a reduction in the size of the projector 1.

### Second Embodiment

Subsequently, a projector in a second embodiment is explained. A difference between this embodiment and the first embodiment is a configuration of a polarization conversion unit. The other components are common to this embodiment and the first embodiment. Therefore, the configuration of the polarization conversion unit is explained below. Members common to the first embodiment are denoted by the same reference numerals and signs and explanation is omitted about details of the members.

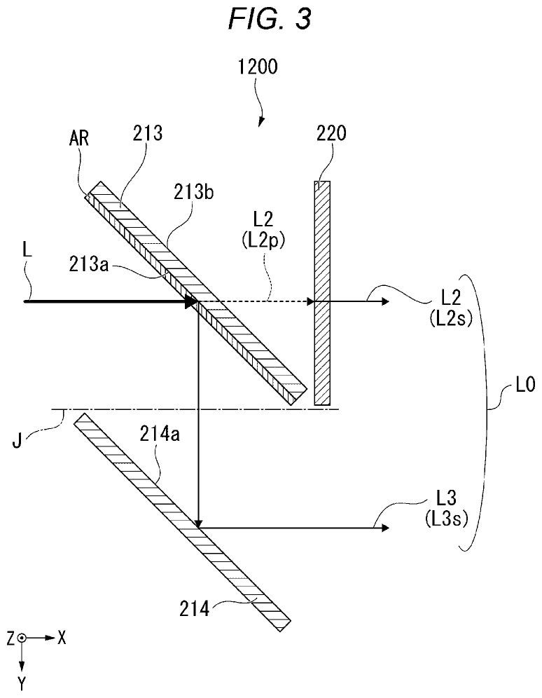

FIG. 3 is a plan view showing a main part configuration of a polarization conversion unit 1200 in this embodiment. FIG. 3 is a plan view of the polarization conversion unit 1200 viewed from the upper side (+Z).

As shown in FIG. 3, in the polarization conversion unit 1200 in this embodiment, the phase difference plate 220 is provided in an optical path of the second light L2 transmitted through the polarizing separation plate 213. That is, the phase difference plate 220 is provided on the light emission surface 213b side of the polarizing separation plate 213.

In the polarization conversion unit 1200 in this embodiment, the third light L3 reflected by the polarizing separation plate 213 and separated from the illumination light L is emitted without being transmitted through the phase difference plate 220.

On the other hand, the second light L2 transmitted through the polarizing separation plate 213 and separated from the illumination light L is transmitted through the phase difference plate 220. The second light L2 is transmitted through the phase difference plate 220 to be converted into an S-polarized light component L2s from the P-polarized light component L2p. The phase difference plate 220 can align the polarization direction (the S-polarized light component L2s) of the second light L2 with the polarization direction (the S-polarized light component L3s) of the third light L3.

As explained above, with the polarization conversion unit 1200 in this embodiment, since the converted light L0 converted into the S-polarized light is made incident on the light modulation device 400 including the incident-side polarization plate 402, a polarized light transmission axis of which is set to the S-polarized light, it is possible to efficiently make the converted light L0 incident on the liquid crystal panel 401. Accordingly, it is possible to improve light use efficiency of the illumination light L emitted from the light source 100.

### Third Embodiment

Subsequently, a projector in a third embodiment is explained. A difference between this embodiment and the first embodiment is a configuration of a polarization conversion unit. The other components are common to this embodiment and the first embodiment. Therefore, the configuration of the polarization conversion unit is explained below. Members common to the first embodiment are denoted by the same reference numerals and signs and explanation is omitted about details of the members.

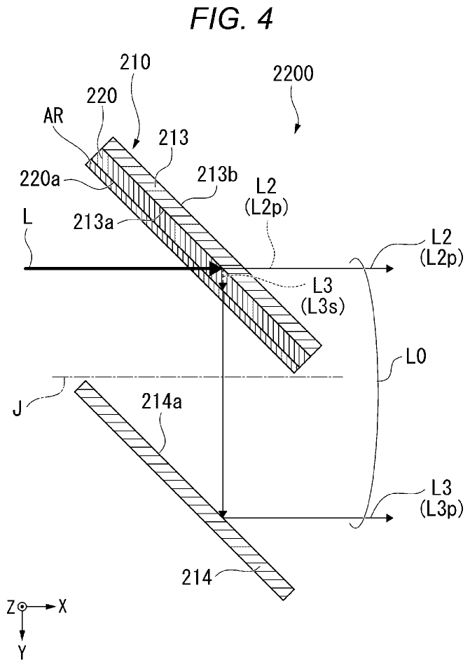

FIG. 4 is a plan view showing a main part configuration of a polarization conversion unit 2200 in this embodiment. FIG. 4 is a plan view of the polarization conversion unit 2200 viewed from the upper side (+Z).

As shown in FIG. 4, in the polarization conversion unit 2200, the phase difference plate 220 is directly provided on the light incident side of the polarizing separation plate 213. Specifically, the phase difference plate 220 is provided on the light incident surface 213a of the polarizing separation plate 213 of the polarizing separator 210.

In the case of this embodiment, the reflection prevention film AR is provided on a surface 220a of the phase difference plate 220. Consequently, since reflection of the illumination light L by the interface between the surface 220a of the phase difference plate 220 and the air layer is suppressed, the illumination light L can be efficiently made incident on the phase difference plate 220.

In the polarization conversion unit 2200 in this embodiment, the illumination light L is transmitted through the phase difference plate 220 provided on the light incident side of the polarizing separation plate 213. At this time, a polarization state of the illumination light L, which is the nonpolarized light, does not change before and after the transmission through the phase difference plate 220. The illumination light L transmitted through the phase difference plate 220 is made incident on the polarizing separation plate 213 and is separated into the second light L2 and the third light L3.

The second light L2 is transmitted through the polarizing separation plate 213 to be separated from the illumination light L.

On the other hand, the third light L3 reflected by the polarizing separation plate 213 and separated from the illumination light L is transmitted through the phase difference plate 220 and reflected toward the superimposing optical system 250 by the reflection plate 214. The third light L3 is transmitted through the phase difference plate 220 to be converted into the P-polarized light component L3p from the S-polarized light component L3s.

The phase difference plate 220 in this embodiment can align the polarization direction (the P-polarized light component L3p) of the third light L3 with the polarization direction (the P-polarized light component L2p) of the second light L2.

As explained above, in the polarization conversion unit 2200 in this embodiment as well, by converting the polarization direction of the converted light L0 into a polarization direction in which the converted light L0 can be transmitted through the incident-side polarization plate 402, it is possible to efficiently make the converted light L0 incident on the liquid crystal panel 401. Accordingly, it is possible to improve light use efficiency of the illumination light L emitted from the light source 100.

### Fourth Embodiment

Subsequently, a projector in a fourth embodiment is explained. A difference between this embodiment and the first embodiment is a configuration of a polarization conversion unit. The other components are common to this embodiment and the first embodiment. Therefore, the configuration of the polarization conversion unit is explained below. Members common to the first embodiment are denoted by the same reference numerals and signs and explanation is omitted about details of the members.

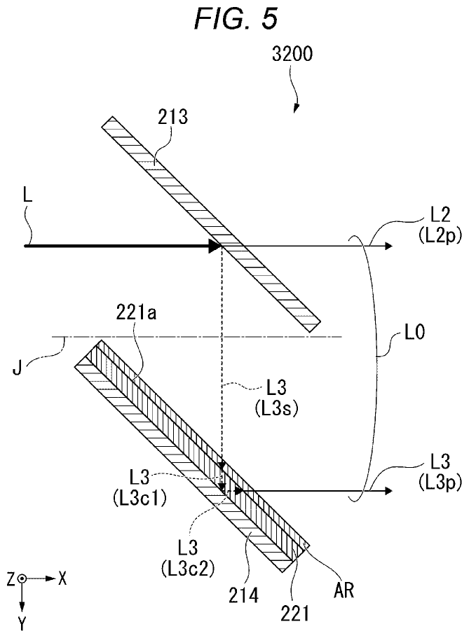

FIG. 5 is a plan view showing a main part configuration of a polarization conversion unit 3200 in this embodiment. FIG. 5 is a plan view of the polarization conversion unit 3200 viewed from the upper side (+Z).

As shown in FIG. 5, in the polarization conversion unit 3200, a phase difference plate 221 is directly provided on the reflection plate 214. Specifically, the phase difference plate 221 is provided on the light reflection surface 214a of the reflection plate 214.

In the case of this embodiment, the reflection prevention film AR is provided on a surface 221a of the phase difference plate 221. Consequently, since reflection of the illumination light L by the interface between the surface 221a of the phase difference plate 221 and the air layer is suppressed, the illumination light L can be efficiently made incident on the phase difference plate 221.

The phase difference plate 221 in this embodiment is configured by a quarter wave plate. The phase difference plate 221 in this embodiment is a plate-like member configured by, for example, extending plate-like resin or forming, with the nanoimprint method, a periodic structure smaller than the wavelength of light on the surface of a plastic substrate. The phase difference plate 221 may be formed using an inorganic material such as crystal, sapphire, lithium niobate, or calcite.

In the polarization conversion unit 3200 in this embodiment, the second light L2 transmitted through the polarizing separation plate 213 and separated from the illumination light L is emitted toward the superimposing optical system 250.

On the other hand, the third light L3 reflected by the polarizing separation plate 213 and separated from the illumination light L is transmitted through the phase difference plate 221 and made incident on the reflection plate 214. The third light L3, which is the S-polarized light component L3s, is transmitted through the phase difference plate 221 to be converted into circularly polarized light L3c1. The third light L3 converted into the circularly polarized light L3c1 is reflected by the reflection plate 214. The third light L3, which is the circularly polarized light L3c1, is reflected by the reflection plate 214 to be converted into circularly polarized light L3c2, a rotation direction of which is opposite to a rotation direction of the circularly polarized light L3c1. The third light L3, which is the circularly polarized light L3c2, is transmitted through the phase difference plate 221 again to be converted into the P-polarized light component L3p and emitted toward the superimposing optical system 250.

The phase difference plate 221 in this embodiment can align the polarization direction (the P-polarized light component L3p) of the third light L3 with the polarization direction (the P-polarized light component L2p) of the second light L2.

As explained above, in the polarization conversion unit 3200 in this embodiment as well, by converting the polarization direction of the converted light L0 into the polarization direction in which the converted light L0 can be transmitted through the incident-side polarization plate 402, it is possible to efficiently make the converted light L0 incident on the liquid crystal panel 401. Accordingly, it is possible to improve light use efficiency of the illumination light L emitted from the light source 100.

### Fifth Embodiment

Subsequently, a projector in a fifth embodiment is explained. A difference between this embodiment and the first embodiment is a configuration of a polarization conversion unit. The other components are common to this embodiment and the first embodiment. Therefore, the configuration of the polarization conversion unit is explained below. Members common to the first embodiment are denoted by the same reference numerals and signs and explanation is omitted about details of the members.

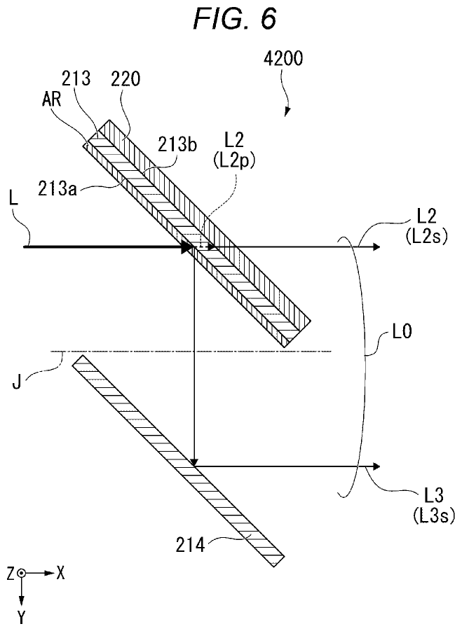

FIG. 6 is a plan view showing a main part configuration of a polarization conversion unit 4200 in this embodiment. FIG. 6 is a plan view of the polarization conversion unit 4200 viewed from the upper side (+Z).

As shown in FIG. 6, in the polarization conversion unit 4200, the phase difference plate 220 is directly provided on the light emission side of the polarizing separation plate 213. Specifically, the phase difference plate 220 is provided on the light emission surface 213b of the polarizing separation plate 213 of the polarizing separator 210.

In the case of this embodiment, the reflection prevention film AR is provided on the light incident surface 213a of the polarizing separation plate 213. Consequently, since reflection of the illumination light L by the interface between the light incident surface 213a of the polarizing separation plate 213 and the air layer is suppressed, the illumination light L can be efficiently made incident on the polarizing separation plate 213.

In the polarization conversion unit 4200 in this embodiment, the third light L3 reflected by the polarizing separation plate 213 and separated from the illumination light L is reflected by the reflection plate 214 to be emitted toward the superimposing optical system 250.

On the other hand, the second light L2 transmitted through the polarizing separation plate 213 and separated from the illumination light L is transmitted through the phase difference plate 220. The second light L2 is transmitted through the phase difference plate 220 to be converted into the S-polarized light component L2s from the P-polarized light component L2p. The phase difference plate 220 can align the polarization direction (the S-polarized light component L2s) of the second light L2 with the polarization direction (the S-polarized light component L3s) of the third light L3.

As explained above, in the polarization conversion unit 4200 in this embodiment as well, by converting the polarization direction of the converted light L0 into the polarization direction in which the converted light L0 can be transmitted through the incident-side polarization plate 402, it is possible to efficiently make the converted light L0 incident on the liquid crystal panel 401. Accordingly, it is possible to improve light use efficiency of the illumination light L emitted from the light source 100.

### Sixth Embodiment

Subsequently, a projector in a sixth embodiment is explained. A difference between this embodiment and the first embodiment is a configuration of a polarization conversion unit. The other components are common to this embodiment and the first embodiment. Therefore, the configuration of the polarization conversion unit is explained below. Members common to the first embodiment are denoted by the same reference numerals and signs and explanation is omitted about details of the members.

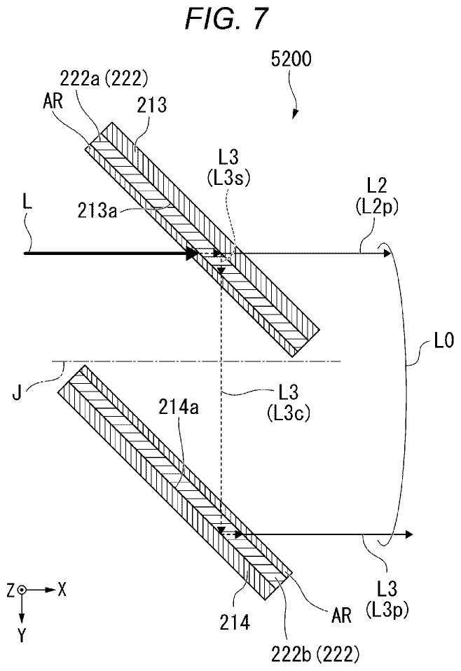

FIG. 7 is a plan view showing a main part configuration of a polarization conversion unit 5200 in this embodiment. FIG. 7 is a plan view of the polarization conversion unit 5200 viewed from the upper side (+Z).

As shown in FIG. 7, in the polarization conversion unit 5200, a phase difference plate 222 includes a first plate 222a and a second plate 222b.

The first plate 222a is directly provided on the light incident side of the polarizing separation plate 213. Specifically, the first plate 222a is provided on the light incident surface 213a of the polarizing separation plate 213.

The second plate 222b is directly provided on the light incident side of the reflection plate 214. Specifically, the second plate 222b is provided on the light reflection surface 214a of the reflection plate 214.

In the case of this embodiment, reflection prevention films AR are respectively provided on the light incident side of the first plate 222a and the light incident side of the second plate 222b. Consequently, since reflection of light by the interface between the first plate 222a and the second plate 222b and the air layer is suppressed, light is efficiently made incident on the first plate 222a and the polarizing separation plate 213.

The first plate 222a is configured by a quarter wave plate and the second plate 222b is configured by a ⅛ phase difference plate. The first plate 222a and the second plate 222b are plate-like members configured by, for example, extending plate-like resin or forming, with the nanoimprint method, a periodic structure smaller than the wavelength of light on the surface of a plastic substrate. The first plate 222a and the second plate 222b may be formed using an inorganic material such as crystal, sapphire, lithium niobate, or calcite.

In the polarization conversion unit 5200 in this embodiment, first, the illumination light L is transmitted through the phase difference plate 220 provided on the light incident surface 213a of the polarizing separation plate 213. At this time, a polarization state of the illumination light L, which is the nonpolarized light, does not change before and after the transmission through the first plate 222a. The illumination light L transmitted through the first plate 222a is made incident on the polarizing separation plate 213 and separated into the second light L2 and the third light L3.

The second light L2 is transmitted through the polarizing separation plate 213 to be separated from the illumination light L.

On the other hand, the third light L3 reflected by the polarizing separation plate 213 and separated from the illumination light L is transmitted through the first plate 222a. The third light L3, which is the S-polarized light component L3s, is transmitted through the first plate 222a to be converted into circularly polarized light L3c. The circularly polarized light L3c is transmitted through the second plate 222b, made incident on the reflection plate 214, and emitted toward the superimposing optical system 250. At this time, the circularly polarized light L3c is reflected by the reflection plate 214 to be converted into a circularly polarized light, a rotation direction of which is opposite to a rotation direction of the circularly polarized light L3c, and is reciprocatingly transmitted through the second plate 222b to be imparted with a phase difference for a quarter wavelength and is converted into the P-polarized light component L3p.

The phase difference plate 222 in this embodiment can align the polarization direction (the P-polarized light component L3p) of the third light L3 with the polarization direction (the P-polarized light component L2p) of the second light L2.

As explained above, in the polarization conversion unit 5200 in this embodiment as well, by converting the polarization direction of the converted light L0 into the polarization direction in which the converted light L0 can be transmitted through the incident-side polarization plate 402, it is possible to efficiently make the converted light L0 incident on the liquid crystal panel 401. Accordingly, it is possible to improve light use efficiency of the illumination light L emitted from the light source 100.

### Seventh Embodiment

Subsequently, a projector according to a seventh embodiment is explained. A difference between this embodiment and the first embodiment is a configuration of a polarization conversion unit. The other components are common to this embodiment and the first embodiment. Therefore, the configuration of the polarization conversion unit is explained below. Members common to the first embodiment are denoted by the same reference numerals and signs and explanation is omitted about details of the members.

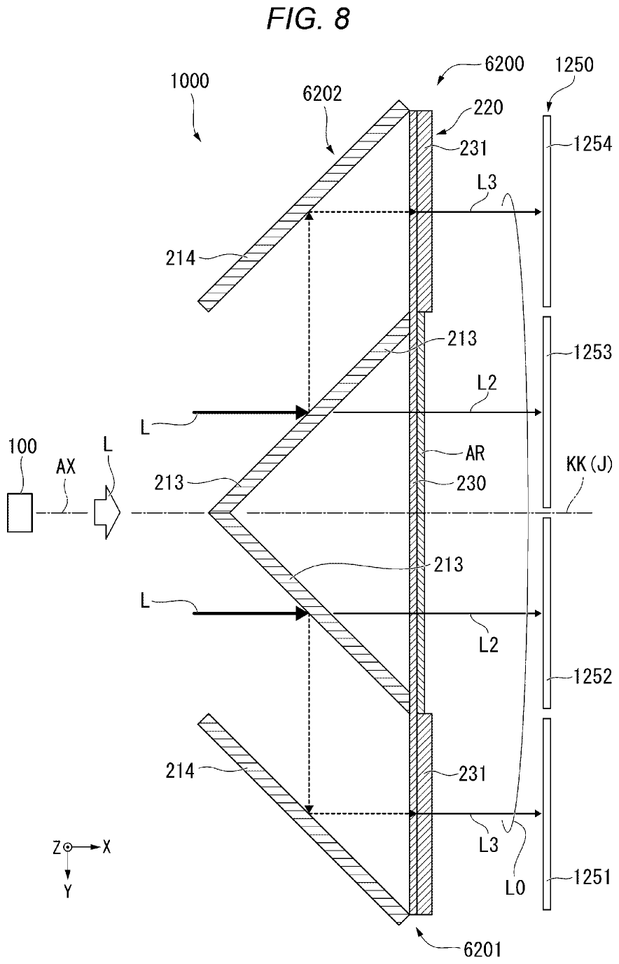

FIG. 8 is a plan view showing a main part configuration of a projector 1000 in this embodiment. FIG. 8 is a plan view of the projector 1000 viewed from the upper side (+Z).

As shown in FIG. 8, the projector 1000 in this embodiment includes a pair of polarization conversion units 6200. The pair of polarization conversion units 6200 is configured by a first polarization conversion unit 6201 and a second polarization conversion unit 6202. The first polarization conversion unit 6201 and the second polarization conversion unit 6202 are disposed to be symmetrical with respect to an imaginary axis KK extending along the illumination optical axis AX of the light source 100. In the case of this embodiment, the imaginary axis KK and the illumination optical axis AX coincide with the reference axis J.

The first polarization conversion unit 6201 is disposed on the lower side (+Y) with respect to the imaginary axis KK. The second polarization conversion unit 6202 is disposed on the upper side (−Y) with respect to the imaginary axis KK. The first polarization conversion unit 6201 and the second polarization conversion unit 6202 respectively have the same configuration as the configuration of the polarization conversion unit 200 in the first embodiment.

Therefore, in each of the first polarization conversion unit 6201 and the second polarization conversion unit 6202, the polarizing separation plate 213 is disposed closer to the imaginary axis KK than the reflection plate 214.

In each of the first polarization conversion unit 6201 and the second polarization conversion unit 6202, the phase difference plate 220 is provided in the optical path of the third light L3 separated from the illumination light L.

In the case of this embodiment, the phase difference plate 220 is configured by providing a phase difference film 231 on a transparent substrate 230 disposed on the light emission side of the polarization conversion unit 6200. With this configuration, since the phase difference plates 220 of the first polarization conversion unit 6201 and the second polarization conversion unit 6202 can be integrated, it is possible to reduce the number of components compared with when the phase difference plates 220 are individually provided in the first polarization conversion unit 6201 and the second polarization conversion unit 6202. Since alignment of the phase difference plates 220 is unnecessary, it is possible to improve assemblability of the polarization conversion unit 6200. In each of the first polarization conversion unit 6201 and the second polarization conversion unit 6202, the reflection prevention film AR is provided on the surface of the transparent substrate 230 on the optical path of the second light L2 separated from the illumination light L. Therefore, since reflection of the second light L2 by the interface between the transparent substrate 230 and the air layer is suppressed, it is possible to efficiently emit the second light L2.

A superimposing optical system 1250 in this embodiment includes a lens section 1251, a lens section 1252, a lens section 1253, and a lens section 1254.

The second light L2 emitted from the first polarization conversion unit 6201 in the converted light L0 emitted from the polarization conversion unit 6200 is made incident on the lens section (a first optical member) 1251.

The third light L3 emitted from the first polarization conversion unit 6201 in the converted light L0 emitted from the polarization conversion unit 6200 is made incident on the lens section (a second optical member) 1252.

The second light L2 emitted from the second polarization conversion unit 6202 in the converted light L0 emitted from the polarization conversion unit 6200 is made incident on the lens section (a first optical member) 1253.

The third light L3 emitted from the second polarization conversion unit 6202 in the converted light L0 emitted from the polarization conversion unit 6200 is made incident on the lens section (a second optical member) 1254.

In the case of this embodiment, a principal ray of the second light L2 emitted from the lens section 1251 and a principal ray of the second light L2 emitted from the lens section 1253 come closer to each other toward the light modulation device 400. A principal ray of the third light L3 emitted from the lens section 1252 and a principal ray of the third light L3 emitted from the lens section 1254 come closer to each other toward the light modulation device 400.

With the superimposing optical system 1250 in this embodiment, the second light L2 and the third light L3 emitted from the first polarization conversion unit 6201 and the second light L2 and the third light L3 emitted from the second polarization conversion unit 6202 can be superimposed in a light irradiation region (an image forming region) of the light modulation device 400.

In this way, in the polarization conversion unit 6200 in this embodiment as well, by converting the polarization direction of the converted light L0 into the polarization direction in which the converted light L0 can be transmitted through the incident-side polarization plate 402, it is possible to efficiently make the converted light L0 incident on the liquid crystal panel 401. Accordingly, it is possible to improve light use efficiency of the illumination light L emitted from the light source 100. With the polarization conversion unit 6200 in this embodiment, since the light beam width of the converted light L0 can be further expanded than the configurations in the other embodiments, it is possible to reduce expansion magnification of the superimposing optical system 1250. Consequently, it is possible to reduce the distance in the reference axis J direction from the superimposing optical system 1250 to the light modulation device 400. It is possible to realize a further reduction in the size of the projector.

In the polarization conversion unit 6200 in this embodiment, an example is explained in which the first polarization conversion unit 6201 and the second polarization conversion unit 6202 respectively have the same configuration as the configuration of the polarization conversion unit 200 in the first embodiment. However, a configuration in which the polarization conversion units in the second to sixth embodiments are symmetrically disposed with respect to the imaginary axis KK may be adopted.

The technical scope of the present disclosure is not limited to the embodiments explained above. Various changes can be added in a range not departing from the gist of the present disclosure.

Besides, specific configurations such as the numbers, dispositions, shapes, and materials of the various components configuring the projector are not limited to the embodiments explained above and can be changed as appropriate.

For example, in the embodiments, an example is explained in which the superimposing optical system 250 that superimposes the converted light L0 on the light modulation device 400 is configured by the Fresnel lens. However, the superimposing optical system 250 may be configured by a concave lens instead of the Fresnel lens. That is, the first lens section 251 and the second lens section 252 may be respectively configured by concave lenses. In this case, the optical axes of the concave lenses configuring the first lens section 251 and the second lens section 252 are disposed in a state in which the optical axes are further tilted in a direction approaching the reference axis J (a tilt state) toward the light modulation device 400.

The superimposing optical system 250 may be configured by reflectors instead of the Fresnel lens. That is, the first lens section 251 may be replaced with a first reflector (a first optical member) and the second lens section 252 may be replaced with a second reflector (a second optical member). By adjusting, as appropriate, installation angles of the first reflector and the second reflector and incident angles of the second light L2 and the third light L3 on the first reflector and the second reflector, the principal ray L2A of the second light L2 emitted from the first reflector and the principal ray L3A of the third light L3 emitted from the second reflector can be brought closer to each other toward the light modulation device 400. That is, the second light L2 reflected by the first reflector and the third light L3 reflected by the second reflector can be superimposed on the light modulation device 400.

When the superimposing optical system 250 is configured by the reflectors, it is easy to adjust the incident angles of the second light L2 and the third light L3 on the reflectors if the optical system 150 that collimates the illumination light L emitted from the light source 100 is omitted.

In the superimposing optical system 1250 in the seventh embodiment as well, the lens section 1251, the lens section 1252, the lens section 1253, and the lens section 1254 may be respectively replaced with reflectors.

In the embodiments, an example is explained in which the polarizing separation plate 213 is configured by the dielectric multilayer film. However, the polarizing separation plate 213 may be configured by a wire grid-type polarizing element in which a plurality of metal thin wires made of aluminum or the like are provided on the entire surface of a substrate at a fine pitch. When the wire grid-type polarizing element is used, it is possible to increase heat resistance of the polarizing separation plate 213.

### Modification

A configuration in which a polarizing separation element configured by a wire grid-type polarizing element is used is explained below as a modification.

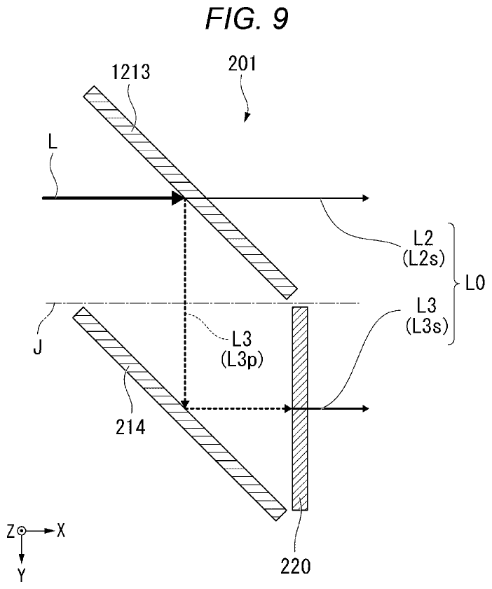

FIG. 9 is a plan view showing a main part configuration of a polarization conversion unit 201 according to the modification. FIG. 9 is a plan view of the polarization conversion unit 201 viewed from the upper side (+Z).

In the polarization conversion unit 201 in this modification shown in FIG. 9, the polarizing separation plate 213 configured by the dielectric multilayer film in the polarization conversion unit 200 in the first embodiment is replaced with a polarizing separation plate 1213 configured by a wire grid-type polarizing element.

The polarizing separation plate 213 in the first embodiment transmits the P-polarized light component (the first linearly polarized light component) in the illumination light L as the second light L2 and reflects the S-polarized light component (the second linearly polarized light component) in the nonpolarized illumination light L as the third light L3.

In contrast, for example, by adjusting an array direction and an angle of the plurality of metal thin wires with respect to the illumination light L, the polarizing separation plate 1213 in this modification configured by the wire grid-type polarizing element can transmit the S-polarized light component (the first linearly polarized light component) L2s in the illumination light L as the second light L2 and reflect the P-polarized light component (the second linearly polarized light component) L3p in the nonpolarized illumination light L as the third light L3.

Therefore, in the polarization conversion unit 201 in this modification, the second light L2, which is the S-polarized light component L2s, transmitted through the polarizing separation plate 1213 and separated from the illumination light L is emitted toward the first lens section 251. The third light L3, which is the P-polarized light component L3p, reflected by the polarizing separation plate 1213 and separated from the illumination light L is transmitted through the phase difference plate 220. The third light L3 is transmitted through the phase difference plate 220 to be converted into the S-polarized light component L3s from the P-polarized light component L3p.

As explained above, with the polarization conversion unit 201 in this modification, by aligning the polarization direction (the S-polarized light component L3s) of the third light L3 with the polarization direction (the S-polarized light component L2s) of the second light L2, the phase difference plate 220 can convert the polarization direction of the converted light L0 into the S-polarized light that can be transmitted through the incident-side polarization plate 402 and efficiently make the converted light L0 incident on the light modulation device 400. Accordingly, it is possible to improve light use efficiency of the illumination light L emitted from the light source 100.

In this modification, the polarization conversion unit 200 in the first embodiment is explained as an example. However, the polarizing separation element in any one of the polarization conversion units in the second to ninth embodiments may be replaced with the wire grid-type polarizing element.

A summary of the present disclosure is noted below.

### Note 1

A projector including:
a light source configured to emit first light, which is non-linearly polarized light;
a polarization conversion unit configured to convert the first light made incident from the light source into predetermined linearly polarized light;
a light modulation device including a liquid crystal panel which modulates the predetermined linearly polarized light converted by the polarization conversion unit; and
a superimposing optical system configured to superimpose, on the liquid crystal panel, the predetermined linearly polarized light made incident from the polarization conversion unit, wherein
the polarization conversion unit includes:
   a polarizing separator configured to separate the first light into second light and third light based on polarized light components; and
   a phase difference plate configured to align polarization directions of the second light and the third light,
the polarizing separator includes a polarizing separation plate and a reflection plate disposed to be separated from and opposed to each other,
the polarizing separation plate is provided in a tilted state with respect to a principal ray of the first light and separates the first light by transmitting a first linearly polarized light component in the first light toward the superimposing optical system as the second light and reflecting, as the third light, a second linearly polarized light component in a polarization direction different from a polarization direction of the first linearly polarized light component in the first light, and
the reflection plate reflects the third light made incident from the polarizing separation plate toward the superimposing optical system.

With the projector in this configuration, a converted light obtained by aligning, with the polarization conversion unit, a polarization direction of the first light, which is the nonpolarized light, emitted from the light source with a predetermined polarization direction can be generated. Therefore, it is possible to more efficiently make the first light emitted from the light source incident on the liquid crystal panel of the light modulation device by converting the first light emitted from the light source into the predetermined polarization direction compared with when the polarization direction of the first light is aligned using a polarization plate. Accordingly, it is possible to improve light use efficiency of the first light emitted from the light source.

Since the polarization conversion unit is configured by the polarizing separation plate and the reflection plate disposed to be separated from each other, it is possible to achieve a reduction in weight compared with when a polarizing separation element and a reflection mirror are provided in an optical member such as a prism.

The polarization conversion unit can reduce expansion magnification of the superimposing optical system by setting a light beam width of the converted light larger than a light beam width of the first light. Consequently, it is possible to reduce the distance from the superimposing optical system to the light modulation device and realize a reduction in the size of the projector.

### Note 2

The projector described in Note 1, wherein the phase difference plate is configured by a half wave plate and provided in an optical path of the third light reflected by the reflection plate.

With this configuration, since the third light reflected by the reflection plate is transmitted through the half wave plate, it is possible to align the polarization direction of the third light with the first linearly polarized light component, which is the polarization direction of the second light.

### Note 3

The projector described in Note 1, wherein the phase difference plate is configured by a half wave plate and provided in an optical path of the second light reflected by the polarizing separation plate.

With this configuration, since the second light transmitted through the polarizing separation plate is transmitted through the half wave plate, it is possible to align the polarization direction of the second light with the second linearly polarized light component, which is the polarization direction of the third light.

### Note 4

The projector described in Note 1, wherein
the polarizing separation plate includes a light incident surface on which the first light is made incident, and
the phase difference plate is configured by a half wave plate and provided on the light incident surface of the polarizing separation plate.

With this configuration, since the third light reflected by the polarizing separation plate is transmitted through the half wave plate, it is possible to align the polarization direction of the third light with the first linearly polarized light component, which is the polarization direction of the second light.

### Note 5

The projector described in Note 1, wherein
the reflection plate includes a light reflection surface that reflects the third light, and
the phase difference plate is configured by a quarter wave plate and provided on the light reflection surface of the reflection plate.

With this configuration, since the third light reflected by the polarizing separation plate is transmitted through the quarter wave plate twice, it is possible to align the polarization direction of the third light with the first linearly polarized light component, which is the polarization direction of the second light.

### Note 6

The projector described in Note 1, wherein
the polarizing separation plate includes a light incident surface on which the first light is made incident and a light emission surface from which the second light is emitted, and
the phase difference plate is configured by a half wave plate and provided on the light emission surface of the polarizing separation plate.

With this configuration, since the second light transmitted through the polarizing separation plate is transmitted through the half wave plate, it is possible to align the polarization direction of the second light with the second linearly polarized light component, which is the polarization direction of the third light.

### Note 7

The projector described in Note 1, wherein
the polarizing separation plate includes a light incident surface on which the first light is made incident,
the reflection plate includes a light reflection surface that reflects the third light and is parallel to the light incident surface, and
an angle formed by the light incident surface and the light reflection surface and a principal ray of the first light is 45°.

With this configuration, it is possible to generate converted light including parallel light beams, polarization directions of which are aligned by collimating the second light transmitted through the polarizing separation plate and the third light reflected by the reflection plate.

### Note 8

The projector described in Note 1, wherein
a pair of the polarization conversion units is disposed to be symmetrical with respect to an imaginary axis extending along an optical axis of the light source, and
in each of the pair of polarization conversion units, the polarizing separation plate is disposed closer to the imaginary axis than the reflection plate.

With this configuration, since the projector includes the pair of polarizing conversion units disposed to be symmetrical with respect to a reference axis, it is possible to expand a light beam width of the converted light. Consequently, since expansion magnification of the superimposing optical system can be reduced, it is possible to reduce the distance from the second optical system to the light modulation device. It is possible to realize a further reduction in the size of the projector.

### Note 9

The projector described in any one of Note 1 to Note 8, further including a collimating optical system provided between the superimposing optical system and the light modulation device and configured to collimate light emitted from the superimposing optical system, wherein
the collimating optical system is configured by a Fresnel lens.

With this configuration, it is possible to reduce a dimension in an axial direction of the projector by reducing thickness in an optical axis direction of the collimating optical system.

### Note 10

The projector described in Note 1, wherein
the superimposing optical system includes:
a first lens section on which the second light emitted from the polarization conversion unit is made incident; and
a second lens section on which the third light emitted from the polarization conversion unit is made incident, and
a principal ray of the second light emitted from the first lens section and a principal ray of the third light emitted from the second lens section come closer to each other toward the light modulation device.

With this configuration, the second light and the third light can be superimposed in a light irradiation region (an image forming region) of the light modulation device. Accordingly, since the superimposing optical system can uniformize, by superimposing the second light and the third light, an in-plane brightness distribution of converted light that illuminates the liquid crystal panel, the liquid crystal panel can generate an excellent image without brightness unevenness in a plane.

### Note 11

The projector described in Note 1, wherein the superimposing optical system is configured by a Fresnel lens.

With this configuration, since the superimposing optical system is configured by a Fresnel lens, it is possible to reduce a dimension in an optical axis direction of the projector.

### Note 12

The projector described in any one of Note 1 to Note 11, wherein the liquid crystal panel includes a color filter.

With this configuration, it is possible to project a full-color image.

### Note 13

The projector described in Note 12, wherein the first light emitted from the light source is white light.

With this configuration, it is possible to generate a full-color image by combining the projector with the liquid crystal panel including the color filter.

What is claimed is:

1. A projector comprising:
a light source configured to emit first light, which is non-linearly polarized light;
a polarization conversion unit configured to convert the first light made incident from the light source into predetermined linearly polarized light;
a light modulation device including a liquid crystal panel, the light modulation device modulating the predetermined linearly polarized light converted by the polarization conversion unit; and
a superimposing optical system configured to superimpose, on the liquid crystal panel, the predetermined linearly polarized light made incident from the polarization conversion unit, wherein
the polarization conversion unit includes:
a polarizing separator configured to separate the first light into second light and third light based on polarized light components; and
a phase difference plate configured to align polarization directions of the second light and the third light,
the polarizing separator includes a polarizing separation plate and a reflection plate disposed to be separated from and opposed to each other,
the polarizing separation plate is provided in a tilted state with respect to a principal ray of the first light and separates the first light by transmitting a first linearly polarized light component in the first light toward the superimposing optical system as the second light and reflecting, as the third light, a second linearly polarized light component in a polarization direction different from a polarization direction of the first linearly polarized light component in the first light, and
the reflection plate reflects the third light made incident from the polarizing separation plate toward the superimposing optical system.

2. The projector according to claim 1, wherein the phase difference plate is configured by a half wave plate and provided in an optical path of the third light reflected by the reflection plate.

3. The projector according to claim 1, wherein the phase difference plate is configured by a half wave plate and provided in an optical path of the second light reflected by the polarizing separation plate.

4. The projector according to claim 1, wherein
the polarizing separation plate includes a light incident surface on which the first light is made incident, and
the phase difference plate is configured by a half wave plate and provided on the light incident surface of the polarizing separation plate.

5. The projector according to claim 1, wherein
the reflection plate includes a light reflection surface that reflects the third light, and
the phase difference plate is configured by a quarter wave plate and provided on the light reflection surface of the reflection plate.

6. The projector according to claim 1, wherein
the polarizing separation plate includes a light incident surface on which the first light is made incident and a light emission surface from which the second light is emitted, and
the phase difference plate is configured by a half wave plate and provided on the light emission surface of the polarizing separation plate.

7. The projector according to claim 1, wherein
the polarizing separation plate includes a light incident surface on which the first light is made incident,
the reflection plate includes a light reflection surface that reflects the third light and is parallel to the light incident surface, and
an angle formed by the light incident surface and the light reflection surface and a principal ray of the first light is 45°.

8. The projector according to claim 1, wherein
a pair of the polarization conversion units is disposed to be symmetrical with respect to an imaginary axis extending along an optical axis of the light source, and
in each of the pair of polarization conversion units, the polarizing separation plate is disposed closer to the imaginary axis than the reflection plate.

9. The projector according to claim 1, further comprising a collimating optical system provided between the superimposing optical system and the light modulation device and configured to collimate light emitted from the superimposing optical system, wherein
the collimating optical system is configured by a Fresnel lens.

10. The projector according to claim 1, wherein
the superimposing optical system includes:
a first optical member on which the second light emitted from the polarization conversion unit is made incident; and
a second optical member on which the third light emitted from the polarization conversion unit is made incident, and
a principal ray of the second light emitted from the first optical member and a principal ray of the third light emitted from the second optical member come closer to each other toward the light modulation device.

11. The projector according to claim 1, wherein the superimposing optical system is configured by a Fresnel lens.

12. The projector according to claim 1, wherein the liquid crystal panel includes a color filter.

13. The projector according to claim 1, wherein the first light emitted from the light source is white light.
